(19) United States
(12) Patent Application Publication
(10) Pub. No.: US 2019/0207182 A1
(43) Pub. Date: Jul. 4, 2019

(54) PRESSURE-NEUTRAL ENERGY SUPPLY DEVICE, ON AN ACCUMULATOR FOR UNDERWATER USE

(71) Applicants: THYSSENKRUPP MARINE SYSTEMS GMBH, Kiel (DE); thyssenkrupp AG, Essen (DE)

(72) Inventors: Christian FRÜHLING, Kiel (DE); Marc SCHIEMANN, Kiel (DE); Willem Hendrik WEHNER, Kiel (DE)

(73) Assignees: THYSSENKRUPP MARINE SYSTEMS GMBH, Kiel (DE); thyssenkrupp AG, Essen (DE)

(21) Appl. No.: 16/326,302

(22) PCT Filed: Aug. 21, 2017
(86) PCT No.: PCT/EP2017/071023

§ 371 Date: Feb. 18, 2019

(30) Foreign Application Priority Data
Aug. 22, 2016 (DE) 10 2016 215 713.2

(51) Int. Cl. H01M 2/10; H01M 10/42

(52) U.S. Cl. CPC H01M 2/1094; H01M 10/425; H01M 2220/20; H01M 2010/4271; H01M 2/1077

(57) ABSTRACT

An energy supply device for underwater use includes at least one first housing. The energy supply device includes a multiplicity of electrochemical cells, wherein the energy supply device includes at least one first electrical jack connection on the outer side of the first housing. The first housing of the energy supply device is filled bubble-free with a low-compressibility fluid. The first housing includes a filling device for filling with the low-compressibility fluid and a discharge device for discharging the low-compressibility fluid. The first housing includes a pressure compensation device.

The invention relates to an energy supply device which is formed from electrochemical cells as energy storage units and without a pressure shell for use at high ambient pressures.

DE 10 2015 000 257 A1 discloses an energy supply device having a pressure shell.

US 2014/027 475 A discloses an underwater vehicle having a battery.

WO 2013/103 679 A1 discloses a pressure-tolerant battery having a housing, a lithium polymer cell and a dielectric fluid.

JP 2001 307 691 A discloses an oil-filled battery.

The use of pressure shells restricts the geometrical options in practice to a cylindrical geometry. Added to this, the pressure shell itself has a large weight. This makes production and transport more expensive.

The dissertation by Mr. Chakrabarti (available at http://dx.doi.org/10.14279/depositonce-4647) gives an overview of pressure-neutral systems.

The object of the invention is to provide an energy supply device for underwater use, having a high volumetric and gravimetric energy density.

This object is achieved by an energy supply device having the features specified in claim 1. Advantageous refinements may be found in the dependent claims, the following description and the drawings.

The energy supply device for underwater use according to the invention comprises at least one first housing. The energy supply device comprises a multiplicity of electrochemical cells. The energy supply device furthermore comprises at least one first electrical jack connection on the outer side of the first housing. The first housing of the energy supply device is filled bubble-free with a low-compressibility fluid. The first housing comprises a filling device for filling with the low-compressibility fluid and a discharge device for discharging the low-compressibility fluid. The first housing comprises a pressure compensation device.

In the context of the invention, a low-compressibility fluid is intended to mean a fluid which, in the event of a change in the pressure from ambient pressure (0.1 MPa) to 50 MPa, exhibits a volume change of less than 25%, preferably less than 10%, particularly preferably less than 5%, exceptionally particularly preferably less than 2%. Gases are usually compressible, while liquids are to be regarded as having low compressibility.

In the context of the invention, a pressure compensation device is intended to mean an apparatus which is actively connected to the ambient pressure in such a way that, in the event of pressure differences between the environment and the inner region of the first housing, the pressure of the inner region is brought approximately to the outer pressure, or a predetermined pressure difference is set up.

The filling device for filling with the low-compressibility fluid may be configured in the form of a filling pipe. The discharge device for discharging the low-compressibility fluid may be configured in the form of an outlet valve.

In another embodiment of the invention, the electrochemical cells are configured in pouch format, so-called pouch cells. To this end, the electrochemical cells are significantly more suitable for use at high pressures in comparison with the conventional rolled structure.

In another embodiment of the invention, the electrochemical cells are lithium-ion, lithium-polymer, lithium-iron phosphate, lithium-cobalt oxide, lithium-manganese oxide, lithium-manganese-cobalt oxide, lithium-nickel-cobalt-aluminum oxide, lithium-sulfur or nickel-cobalt-aluminum-oxide cells. Lithium-iron phosphate cells or lithium-manganese oxide cells, particularly preferably lithium-iron phosphate cells, are preferred.

In another embodiment of the invention, the electrochemical cells comprise a graphite anode or a lithium titanate anode, a graphite anode being preferred.

In another embodiment of the invention, the first housing can be stacked in the immersed state. Since under water the buoyancy leads to a lower load when stacking, it may be advantageous to configure the first housing for example corresponding to an ISO container according to ISO 668, even though on land the statics do not allow stackability.

In particular, provision may be made that the first housing comprises a coupling apparatus, which can be actuated in an automated fashion by means of a remote control line. It is therefore possible to stack a plurality of energy supply apparatuses on one another at their installation site and couple them together.

In another embodiment of the invention, the first housing consists of one or more materials, the materials being selected from the group consisting of steel, aluminum, aluminum alloys, titanium, titanium alloys, plastic, composite materials, in particular glass fiber-reinforced plastics or carbon fiber-reinforced plastics.

The steel may, for example, be a steel having a carbon content of less than 0.05%, a silicon content of ≤1%, a manganese content of ≤2%, a phosphorus content of ≤0.045%, a sulfur content of ≤0.015%, a chromium content of from 16.5 to 18.5%, a molybdenum content of from 2.5 to 3%, a nickel content of from 10.5 to 13% and a nitrogen content of ≤0.011%. In this case, a hardness HB of 215 and a modulus of elasticity of 200 kN/mm² are obtained. For example, it is a steel having a carbon content of less than 0.03%, a silicon content of ≤1%, a manganese content of ≤2%, a phosphorus content of ≤0.035%, a sulfur content of ≤0.015%, a chromium content of from 21 to 23%, a molybdenum content of from 2.5 to 3.5%, a nickel content of from 4.5 to 6.5% and a nitrogen content of from 0.1 to 0.22%. In this case, a hardness HB of 270 and a modulus of elasticity of 200 kN/mm² are obtained. Different component parts may be made of the same steel or different steels.

In another embodiment of the invention, the first housing can be evacuated. In order to be able to fill the first housing bubble-free with a low-compressibility fluid, it is advantageous to evacuate the first housing before filling. To this end, the first housing must be configured in such a way that it withstands a negative pressure of preferably 1 bar.

In another embodiment of the invention, the first housing, as well as construction elements used, are optimized for use as a fluid-compensated pressure-neutral system. In particular welded and screw connections are configured in such a way that no cavities can be formed.

In another embodiment of the invention, the first housing is configured securely against lightning strikes. During transport over land or over water, it is necessary to prevent overcharging of the cells from taking place, since this increases the fire risk. Measures to avoid receiving electrical energy from lightning are therefore expedient.

In another embodiment of the invention, the low-compressibility fluid is selected from the group consisting of mineral oil, silicone oil, in particular low-viscosity silicone oil, pentaerythritol tetra fatty acid esters. Low-viscosity silicone oil and pentaerythritol tetra fatty acid esters are preferred.

Pentaerythritol tetra fatty acid esters are fully biodegradable. Even in the event of an accident under water, there is therefore no risk to the environment.

Silicone oil exhibits particularly good long-term stability.

In another embodiment of the invention, the pressure compensation device has an equilibration volume of at most 10%, preferably at most 5%, particularly preferably at most 2% of the internal volume of the first housing. In particular, provision may be made that the equilibration volume of the pressure compensation device is at least large enough so that the compression of the low-compressibility fluid and of the components located inside the first housing, for example further pressure shells or electrochemical cells, can be compensated for at the maximum immersion pressure, or immersion depth.

In another embodiment of the invention, components with a high maintenance intensity are arranged outside the first housing.

In addition to electrochemical cells, the energy supply device according to the invention may comprise power electronics. In particular, a control and monitoring device, power switches, current converters, balancing devices, and/or devices for communication to a remotely located control center, may be provided as power electronics.

In another embodiment of the invention, the energy supply device comprises a pressure shell for receiving pressure-sensitive components. Since only few components need to be arranged in the pressure shell, the latter can be made relatively small and therefore also light.

In another embodiment of the invention, the power electronics, a control computer and/or a current converter are arranged in one or more second housings outside the first housing, the second housing being configured as a pressure shell.

In another embodiment of the invention, the power electronics, a control computer and/or a current converter are configured pressure-neutrally.

In another embodiment of the invention, the second housing is filled with a heat-transfer fluid. The thermally conductive fluid may be a gas, in particular helium, or a liquid, in particular a silicone oil, or a thermally conductive paste.

In another embodiment of the invention, the second housing is enclosed by a fourth housing which has a connection to the environment, i.e. in the immersed state water passes behind it. The first housing and the fourth housing preferably together form the structure of an ISO container.

In another embodiment of the invention, power electronics are arranged in a third housing inside the first housing, the third housing being configured as a pressure shell. In this way, on the one hand, the geometry of the first housing is not modified, which is advantageous when the first housing is a housing in the form of an ISO container. On the other hand, the pressure shell can be relatively small and therefore light, since it only needs to receive the power electronics.

In another embodiment, the power electronics are configured pressure-neutrally and are arranged in the first housing. In the context of the invention, pressure-neutral means that the power electronics are mounted in the first housing without a pressure-tight housing in incompressible elastomers, for example silicone or polyurethane and is insensitive to the ambient pressure.

In another embodiment of the invention, the pressure compensation device is formed by at least one cylindrical pressure equilibration vessel, preferably by two cylindrical pressure equilibration vessels.

In another embodiment of the invention, the cylindrical pressure equilibration vessels comprise a piston prestressed by a spring, the spring being arranged in such a way that an elevated pressure relative to the environment is formed inside the first housing.

In another embodiment of the invention, the pressure compensation device comprises a pressure equilibration vessel having a flexible diaphragm. The diaphragm is prestressed, for example by means of a pressurized reservoir or a spring.

In another embodiment of the invention, the pressure compensation device comprises a pressure equilibration vessel having a flexible vessel. The vessel may ensure an elevated pressure inside the container by prestretching.

In another embodiment of the invention, the pressure is elevated by less than 10 kPa, preferably by less than 5 kPa. The elevation of the pressure on the inside has the effect that, in the event of an accident, no saline seawater can initially enter the first housing. In this way, the electrochemical cells and the further components are protected.

In another embodiment of the invention, the electrochemical cells comprise an electrolyte, the electrolyte comprising a solvent, the solvent being selected from the group consisting of dimethyl carbonate, diethyl carbonate, ethyl methyl carbonate, ethylene carbonate.

In another embodiment of the invention, the electrochemical cells have a length, a width and a height, the length being between 5 cm and 100 cm, preferably between 20 cm and 40 cm, the width being between 5 cm and 50 cm, preferably between 10 cm and 30 cm, the thickness being between 1 mm and 50 mm, preferably between 5 mm and 20 mm.

In another embodiment of the invention, the electrochemical cells respectively have a capacity of from 10 Ah to 100 Ah, preferably between 30 Ah and 50 Ah. The larger the individual cell is, the less elaborate the battery management is. On the other hand, the difficulty in production, particularly with the preferred cell type, increases with the size, so that this capacity represents an optimum of these two sizes.

In another embodiment of the invention, respectively from 80 to 120 electrochemical cells are electrically connected to form a module. Furthermore preferably, respectively from 8 to 15 modules are electrically connected to form a compartment. Furthermore preferably, respectively from 15 to 20 compartments are electrically connected to form an overall unit.

Particularly preferably, compartments are made of individually replaceable component parts, so that compartments can be produced in a standardized fashion and easily replaced if required. Compartments preferably have a frame or housing, by means of which the compartments can be connected to one another and/or to the first housing. Particularly preferably, the compartments comprise anchoring points for a mechanical transfer, for example by means of a crane or forklift truck.

In particular, 96 electrochemical cells are connected in parallel to form a module, 12 modules are connected in series to form a compartment, and 18 compartments are connected in series to form an overall unit.

In another embodiment of the invention, the energy supply device comprises a battery management system, which in particular prevents overcharging of the cells and therefore minimizes the fire risk.

In another embodiment of the invention, the energy supply device comprises at least one balancer (cell charging state balancer). A balancer is used in order to balance different charging states of the cells.

In another embodiment of the invention, the balancer may establish a balance passively, by means of resistors. Each compartment shares one balancer plus resistor.

In another embodiment of the invention, the resistors are in contact with the outer skin of the container, in order to dissipate heat directly to the container environment.

In one alternative embodiment, the balancer may comprise active electrical components and balance charging states.

In another embodiment of the invention, the various component parts which are located inside the first housing are arranged in groups, each group being configured so as to be transportable by itself. Particularly preferably, each group has a cross section which is slightly smaller than the cross section of the first housing. For example, all the component parts are arranged in three, four or five groups. The groups are introduced successively into the first housing and connected to one another and/or to the first housing in the final position. For example, the energy supply device comprises four groups, the first group, the second group and the third group respectively comprising, for example, six compartments. The fourth group comprises for example a DC/DC converter, a master computer and optionally further components.

In another embodiment of the invention, the energy supply device can be connected to a cooling system for transport and/or storage and/or charging. Particularly preferably, the connection is carried out by means of the filling device for filling with the low-compressibility fluid and the discharge device for discharging the low-compressibility fluid. Particularly preferably, the cooling system may be configured in a similar way to a cooling system that can be connected to an ISO container.

In another embodiment of the invention, the first housing comprises cooling fins at least in some positions on the outer side.

In another embodiment of the invention, the energy supply device comprises at least one first circulation device for passive circulation of the low-compressibility fluid. The at least one first circulation device may be a guide plate which reinforces the thermal convection.

In another embodiment of the invention, the energy supply device comprises at least one second circulation device for active circulation of the low-compressibility fluid. Preferably, the at least one second circulation device comprises at least one pump device, preferably a geared pump.

In another embodiment of the invention, the energy supply device comprises a first circulation device and a second circulation device. Particularly preferably, the energy supply device additionally comprises a temperature monitoring device and a drive device for the second circulation device. If the temperature exceeds a particular amount, the second circulation device is activated. At lower temperatures, the latter is deactivated to save energy.

In another embodiment of the invention, the energy supply comprises an active cooling device, the active cooling device being usable to cool the energy supply device in the water or on land. Preferably, the cooling device is an air/air heat exchanger or a water/air heat exchanger, which releases the waste heat into the water, or on land to the ambient air. When the energy supply device is being used under water, cooling through the walls of the first housing is preferably sufficient. In one particular embodiment, the active cooling device may be separately connectable to the first housing. The advantage of this embodiment is that the active cooling device does not need to be configured for operation under water.

In another embodiment of the invention, the first housing has the external dimensions of a 20-foot container, about 6 m times 2.4 m times 2.6 m, or the external dimensions of a 40-foot container, about 12 m times 2.4 m times 2.6 m. Particularly preferably, the first housing also comprises the connection devices of an ISO container according to ISO 668.

In another embodiment of the invention, the energy supply device has a vertical central axis, the vertical central axis being configured in order to receive the primary lines and for free convection of the low-compressibility fluid.

In another embodiment of the invention, the energy supply device comprises a first electrical jack connection and a second electrical jack connection, the first electrical jack connection being configured as an electrical output, and the second electrical jack connection being configured as an electrical input.

The energy supply device according to the invention is explained in more detail below with the aid of an exemplary embodiment represented in the drawing.

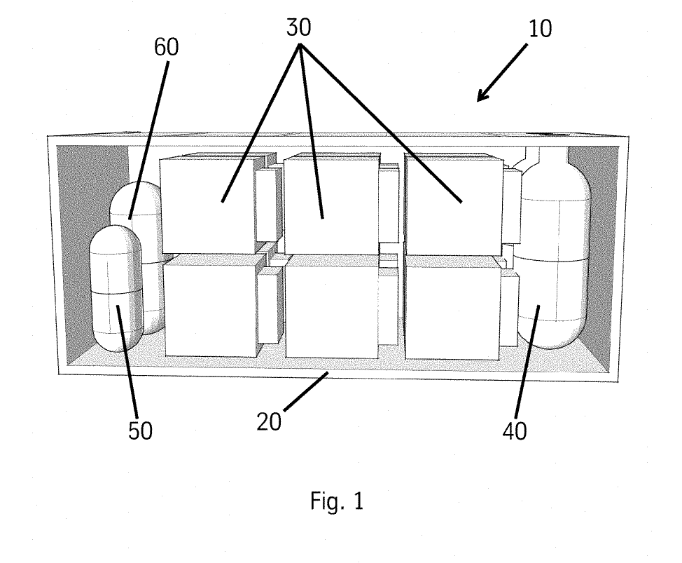

FIG. 1 lateral view of an exemplary energy supply device.

The energy supply device 10 shown in FIG. 1 is omitting one side wall of the first housing 20. The first housing 20 has the shape of a 40-foot ISO container. The first housing 20 is configured in such a way that the first housing 20 withstands a pressure of 110 kPa. In this way, the first housing 20 can be evacuated and operated under water with a slight positive pressure. On the inside, there are compartments 30, which consist of 12 modules connected in series, the modules respectively consisting of 96 electrochemical cells connected in parallel. The interior of the first housing 20 is filled with a low-compressibility fluid. By means of two pressure compensation devices 40, the internal pressure is maintained approximately at the level of the external pressure. To this end, the pressure compensation devices 40 respectively have a connection to the environment on the upper side of the first housing 20. The pressure compensation devices 40 ensure a slight positive pressure of 1 kPa inside the first housing. In addition, the energy supply device 10 comprises a control computer 50 and a current converter 60, the control computer 50 and the current converter 60 respectively being arranged in a further housing inside the first housing 20, the further housings being pressure shells.

### REFERENCES

10 energy supply device
20 first housing
30 compartment
40 pressure compensation device
50 control computer
60 current converter

1.-19. (canceled)

20. An energy supply device for underwater use; comprising:
a first housing having an outer side;
a plurality of electrochemical cells;
at least one first electrical jack connection on the outer side;
a low-compressibility fluid filling the first housing, the fluid free of bubbles;
wherein the first housing comprises a filling device for filling with the low-compressibility fluid and a discharge device configured to discharge the low-compressibility fluid; and
wherein the first housing comprises a pressure compensation device.

21. The energy supply device of claim 20, wherein the electrochemical cells are configured in pouch format.

22. The energy supply device of claim 20, wherein the first housing is configured to be stackable in the immersed state.

23. The energy supply device of claim 20, wherein the first housing is configured to be evacuated.

24. The energy supply device of claim 20, wherein the pressure compensation device has an equilibration volume of at most 10% of the internal volume of the first housing.

25. The energy supply device of claim 20, wherein the pressure compensation device has an equilibration volume of at most 5% of the internal volume of the first housing.

26. The energy supply device of claim 20, wherein the pressure compensation device has an equilibration volume of at most 2% of the internal volume of the first housing.

27. The energy supply device of claim 20, comprising power electronics arranged in a second housing disposed outside the first housing, the second housing being configured as a pressure shell.

28. The energy supply device of claim 20, comprising power electronics are arranged in a third housing disposed inside the first housing, the third housing being configured as a pressure shell.

29. The energy supply device of claim 20, wherein the pressure compensation device is formed by at least one cylindrical pressure equilibration vessel

30. The energy supply device of claim 20, wherein the pressure compensation device is formed by two cylindrical pressure equilibration vessels.

31. The energy supply device of claim 30, wherein the pressure equilibration vessels contain a device which maintains an elevated pressure relative to the environment inside the first housing.

32. The energy supply device of claim 31, wherein the pressure is elevated by less than 10 kPa.

33. The energy supply device of claim 31, wherein the pressure is elevated by less than 5 kPa.

34. The energy supply device of claim 20, wherein the electrochemical cells respectively have a capacity of from 10 Ah to 100 Ah.

35. The energy supply device of claim 20, wherein the electrochemical cells are electrically connected to form a module.

36. The energy supply device of claim 20, wherein the energy supply device comprises a battery management system.

37. The energy supply device of claim 20, wherein the energy supply device comprises at least one cell charging state balancer.

38. The energy supply device of claim 20, wherein the energy supply device is configured to be connected to a cooling system for transport and/or storage and/or charging.

39. The energy supply device of claim 20, wherein the energy supply device comprises at least one first circulation device for passive circulation of the low-compressibility fluid.

40. The energy supply device of claim 39, wherein the energy supply device comprises at least one second circulation device for active circulation of the low-compressibility fluid.

41. The energy supply device of claim 20, wherein the energy supply device has a vertical central axis, the vertical central axis being configured in order to receive the primary lines and for free convection of the low-compressibility fluid.
